(19) United States
(12) Patent Application Publication
(10) Pub. No.: US 2026/0303438 A1
(43) Pub. Date: Oct. 1, 2026

(54) FAILURE DIAGNOSIS DEVICE

(71) Applicant: TOYOTA JIDOSHA KABUSHIKI KAISHA, Toyota-shi (JP)

(72) Inventor: Shingo TOMIDA, Toyota-shi (JP)

(73) Assignee: TOYOTA JIDOSHA KABUSHIKI KAISHA, Toyota-shi (JP)

(21) Appl. No.: 19/551,843

(22) Filed: Feb. 27, 2026

(30) Foreign Application Priority Data
Mar. 28, 2025 (JP) 2025-056324

(51) Int. Cl. H04L 41/0631; H04L 12/40

(52) U.S. Cl. CPC H04L 41/0631; H04L 12/40

(57) ABSTRACT

A communication network system includes a first network in which a relay device and a node are connected in parallel through a communication bus to perform CAN communication, and a second network in which a switching device and a node are connected to each other in a one-to-one manner by a communication cable to perform Ethernet communication. The node included in the first network including both the target node and the switching device executes, in a case where the Ethernet communication executed between a target node and the switching device is interrupted, reading of diagnosis information by using the CAN communication. A failure diagnosis device determines, in a case where the diagnosis information is recorded in one of the target node and the switching device, that the failure has occurred in the node in which the diagnosis information is recorded.

### CROSS-REFERENCE TO RELATED APPLICATION

This application claims priority to Japanese Patent Application No. 2025-056324 filed on Mar. 28, 2025. The disclosure of the above-identified application, including the specification, drawings, and claims, is incorporated by reference herein in its entirety.

### BACKGROUND

### 1. Technical Field

The present disclosure relates to a failure diagnosis device.

### 2. Description of Related Art

Japanese Unexamined Patent Application Publication No. 2008-278403 (JP 2008-278403 A) discloses a communication network system. The communication network system includes a plurality of nodes. The nodes communicate with each other through a communication bus according to a CAN protocol. CAN is an abbreviation for Controller Area Network.

Each of the nodes is connected to the communication bus via a monitoring device including a switching unit. The monitoring device changes a connection relationship on the communication bus by using the switching unit in a case where an abnormality is detected on the communication bus. The monitoring device specifies a location at which the abnormality has occurred in the communication network system by determining whether the abnormality has occurred on the communication bus again.

### SUMMARY

In the communication network system, the node may execute communication according to an Ethernet protocol in addition to the communication according to the CAN protocol. In the communication network system, efficiently repairing the abnormality by specifying a location at which the abnormality has occurred is desired even in a case where the abnormality has occurred in the communication according to the Ethernet protocol.

A failure diagnosis device for solving the problem is a failure diagnosis device for a communication network system. The communication network system includes a plurality of nodes, a plurality of communication buses, and a plurality of communication cables.

The communication network system includes a first network in which a relay device that relays CAN communication to which a CAN protocol is applied and a group of nodes are connected in parallel through the communication buses to perform the CAN communication, the relay device and the group of nodes being included in the plurality of nodes.

The communication network system includes a second network in which a switching device that relays Ethernet communication to which an Ethernet protocol is applied and another group of nodes are connected to each other in a one-to-one manner by the communication cables to perform the Ethernet communication, the switching device and the other group of nodes being included in the plurality of nodes.

The relay device and the switching device are connected to each other through the communication buses.

A target node is the node that is connected to the relay device through the communication bus and is connected to the switching device through the communication cable. The node included in the first network including both the target node and the switching device executes, when the Ethernet communication executed between the target node and the switching device is interrupted, reading of diagnosis information that is a record indicating that an abnormality is detected by a self-abnormality diagnosis function of the target node and the switching device by using the CAN communication.

The failure diagnosis device confirms a result of the reading of the diagnosis information, and determines, when the diagnosis information is recorded in any one of two nodes that are the target node and the switching device, that a failure has occurred in the node in which the diagnosis information is recorded, the node being one of the target node and the switching device.

The failure diagnosis device can specify, even when the Ethernet communication through the communication cable is interrupted, a location at which the failure has occurred by confirming the diagnosis information through the CAN communication through the communication bus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of a communication network system of a first embodiment;

FIG. 2 is a sequence diagram showing an aspect of communication executed in a case where a fourth node in FIG. 1 is added to the communication network system;

FIG. 3 is a sequence diagram showing an aspect of communication executed in a case where an Ethernet communication executed by the fourth node and a switching device in FIG. 1 is interrupted; and

FIG. 4 is a sequence diagram showing an aspect of communication executed in a case where an Ethernet communication executed by a fourth node and a switching device in a communication network system of a second embodiment is interrupted.

### DETAILED DESCRIPTION OF EMBODIMENTS

### First Embodiment

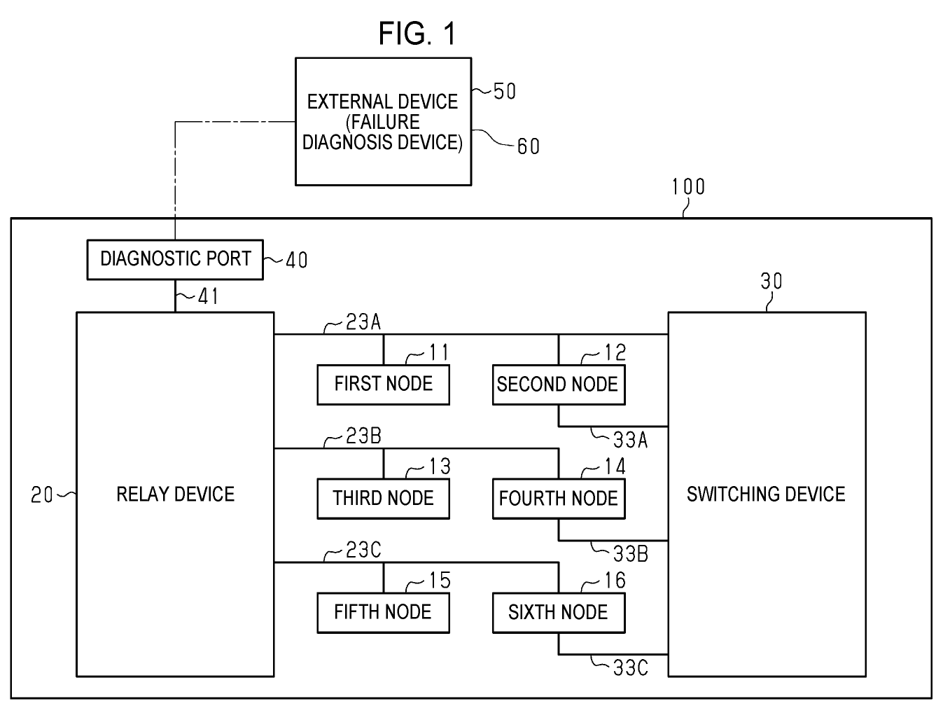

Hereinafter, a first embodiment of the failure diagnosis device will be described with reference to FIGS. 1-3.

### Configuration of Communication Network System 100

The communication network system 100 is mounted on a vehicle. The communication network system 100 includes a plurality of nodes.

As shown in FIG. 1, the communication network system 100 includes a first node 11, a second node 12, a third node 13, a fourth node 14, a fifth node 15, and a sixth node 16 as the nodes.

As shown in FIG. 1, the communication network system 100 includes a relay device 20 and a switching device 30 as the nodes, in addition to the first node 11 to the sixth node 16.

The communication network system 100 includes a first network. The first network is a network in which the relay device 20 and the nodes are connected in parallel through communication buses. The communication network system 100 includes a first communication bus 23A, a second communication bus 23B, and a third communication bus 23C as the communication buses. The node constituting the first network executes CAN communication to which a CAN protocol is applied in the first network.

As shown in FIG. 1, the relay device 20, the first node 11, the second node 12, and the switching device 30 are connected in parallel to the first communication bus 23A. The nodes connected to the first communication bus 23A constitute the first network. The relay device 20, the first node 11, the second node 12, and the switching device 30 execute the CAN communication through the first communication bus 23A.

As shown in FIG. 1, the relay device 20, the third node 13, and the fourth node 14 are connected in parallel to the second communication bus 23B. The nodes connected to the second communication bus 23B constitute the first network. The relay device 20, the third node 13, and the fourth node 14 execute the CAN communication through the second communication bus 23B.

As shown in FIG. 1, the relay device 20, the fifth node 15, and the sixth node 16 are connected in parallel to the third communication bus 23C. The nodes connected to the third communication bus 23C constitute the first network. The relay device 20, the fifth node 15, and the sixth node 16 execute the CAN communication through the third communication bus 23C.

The relay device 20 relays the CAN communication executed between the communication buses. The relay device 20 transmits data to another communication bus in a case where the data is received from the communication bus by the CAN communication.

The communication network system 100 includes a second network. The second network is a network in which the switching device 30 and the nodes are connected to each other in a one-to-one manner by communication cables. The communication network system 100 includes a first communication cable 33A, a second communication cable 33B, and a third communication cable 33C as the communication cables. The node constituting the second network executes Ethernet communication to which an Ethernet protocol is applied in the second network.

As shown in FIG. 1, the second node 12 and the switching device 30 are connected to each other in a one-to-one manner by the first communication cable 33A. The node connected to the first communication cable 33A constitutes the second network. The second node 12 and the switching device 30 execute the Ethernet communication through the first communication cable 33A.

As shown in FIG. 1, the fourth node 14 and the switching device 30 are connected to each other in a one-to-one manner by the second communication cable 33B. The node connected to the second communication cable 33B constitutes the second network. The fourth node 14 and the switching device 30 execute the Ethernet communication through the second communication cable 33B.

As shown in FIG. 1, the sixth node 16 and the switching device 30 are connected to each other in a one-to-one manner by the third communication cable 33C. The node connected to the third communication cable 33C constitutes the second network. The sixth node 16 and the switching device 30 execute the Ethernet communication through the third communication cable 33C.

The switching device 30 relays the Ethernet communication performed between the nodes. The switching device 30 transmits data to a node connected to another communication cable through the Ethernet communication in a case where the data is received from the node through the communication cable.

As shown in FIG. 1, the communication network system 100 includes a diagnostic port 40. The diagnostic port 40 is connected to the relay device 20 through a communication line 41. The communication line 41 is, for example, a communication cable.

FIG. 1 shows an external device 50. The external device 50 is not a node constituting the communication network system 100. The external device 50 is, for example, a tool for executing failure diagnosis, which is held by a dealer or the like. The external device 50 can communicate with the relay device 20 by being connected to the diagnostic port 40.

The external device 50 is a failure diagnosis device 60 in the communication network system 100. The failure diagnosis device 60 specifies a location at which the failure has occurred in the communication network system 100 in a case where the Ethernet communication executed between the target node and the switching device 30 is interrupted.

The target node is a node that is connected to the relay device 20 through the communication bus and is connected to the switching device 30 through the communication cable. In the communication network system 100, the second node 12, the fourth node 14, and the sixth node 16 are the target nodes.

The relay device 20 is connected to four nodes including the second node 12, the fourth node 14, the sixth node 16, and the switching device 30 through the communication bus. That is, the relay device 20 is a node included in the first network including both the target node and the switching device 30.

### Aspect of Communication Executed in a case where Node is Enabled to Communicate

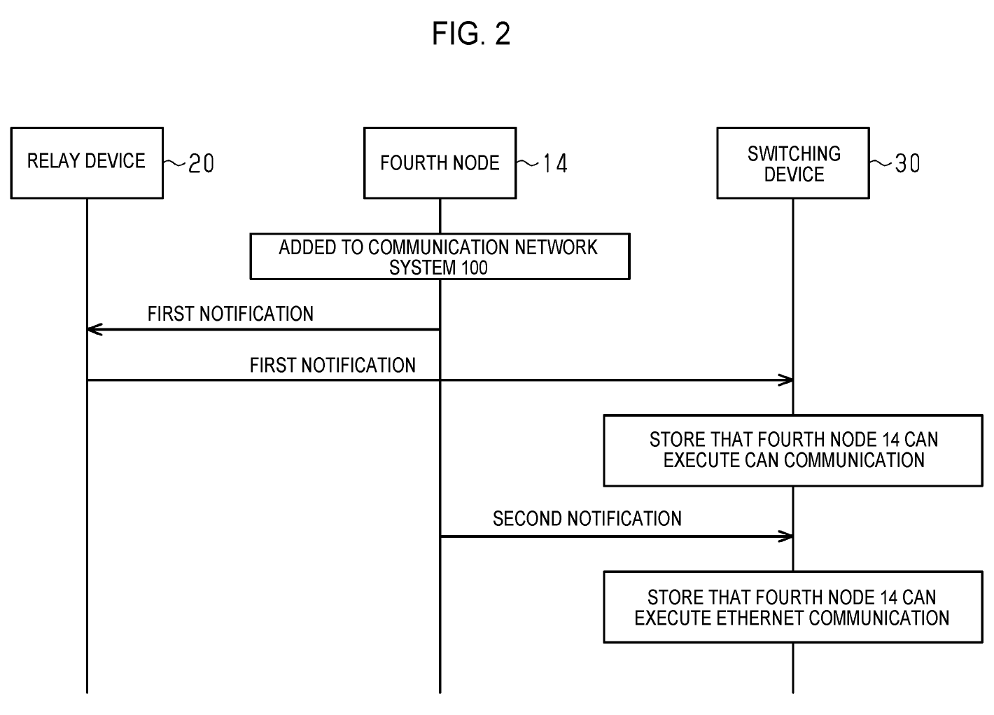

FIG. 2 shows an aspect of communication executed in a case where the fourth node 14 is added to the communication network system 100 from a state where the communication network system 100 does not include the fourth node 14.

The fourth node 14 can execute the CAN communication from the time the fourth node 14 is added to the communication network system 100. As shown in FIG. 2, the fourth node 14 transmits a first notification to the relay device 20 by the CAN communication through the second communication bus 23B after being added to the communication network system 100. The first notification is a notification indicating that the CAN communication can be executed.

As shown in FIG. 2, the relay device 20 transmits the received first notification to the switching device 30 by the CAN communication through the first communication bus 23A after receiving the first notification from the fourth node 14. As shown in FIG. 2, the switching device 30 stores that the fourth node 14 can execute the CAN communication after receiving the first notification from the relay device 20.

As described above, the node in the communication network system 100 transmits the first notification in a case where the CAN communication can be executed. In a case where the node can execute the CAN communication from the time the node is added to the communication network system 100, the time at which the node can execute the CAN communication is the time at which the node is added to the communication network system 100.

A node originally included in the communication network system 100 may be connected to the communication bus later and may be able to execute the CAN communication by changing an installation location. In this case, the time at which the node can execute the CAN communication is the time at which the node is connected to the communication bus.

In the communication network system 100, a node that is originally connected to the communication bus may be able to execute the CAN communication by being updated from a state where the node is not programmed to execute the CAN communication. In this case, the time at which the node can execute the CAN communication is the time at which the node is updated.

The relay device 20 acquires the first notification from the node in a case where the node can execute the CAN communication in the communication network system 100, and transmits the acquired first notification to the switching device 30. The switching device 30 that has received the first notification stores that the node that has transmitted the first notification can execute the CAN communication.

The fourth node 14 can execute the Ethernet communication from the time the fourth node 14 is added to the communication network system 100. As shown in FIG. 2, the fourth node 14 transmits a second notification to the switching device 30 by the Ethernet communication through the second communication cable 33B after being added to the communication network system 100. The second notification is a notification indicating that the Ethernet communication can be executed.

As shown in FIG. 2, the switching device 30 stores that the fourth node 14 can execute the Ethernet communication after receiving the second notification from the fourth node 14.

As described above, the node in the communication network system 100 transmits the second notification in a case where the Ethernet communication can be executed. In a case where the node can execute the Ethernet communication from the time the node is added to the communication network system 100, the time at which the node can execute the Ethernet communication is the time at which the node is added to the communication network system 100.

A node originally included in the communication network system 100 may be connected to the communication cable later and may be able to execute the Ethernet communication by changing an installation location. In this case, the time at which the node can execute the Ethernet communication is the time at which the node is connected to the communication cable.

In the communication network system 100, the node is originally connected to the communication cable. On the other hand, in the communication network system 100, a node may be able to execute the Ethernet communication by being updated from a state where the node is not programmed to execute the Ethernet communication. In this case, the time at which the node can execute the Ethernet communication is the time at which the node is updated.

The switching device 30 acquires the second notification from the node in a case where the node can execute the Ethernet communication in the communication network system 100. The switching device 30 stores that the node that has transmitted the second notification can execute the Ethernet communication.

As described above, the switching device 30 stores the type of communication that can be executed for each node in the communication network system 100 based on the information acquired by the switching device 30 and the relay device 20.

### Aspect of Communication Executed in a case where Ethernet Communication is Interrupted

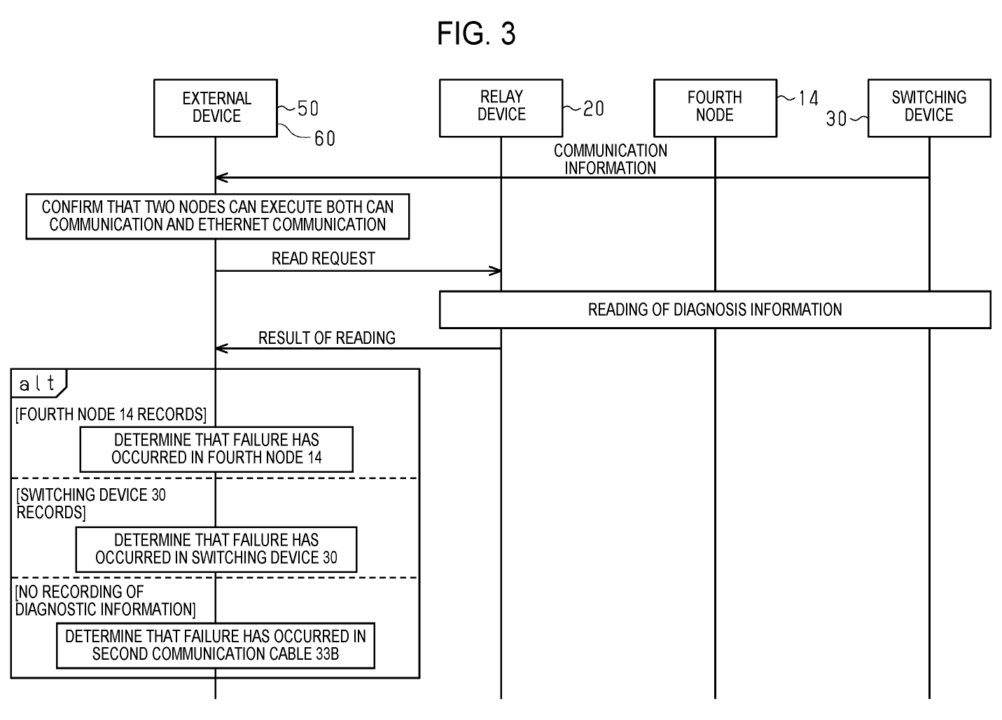

FIG. 3 shows an aspect of communication executed in a case where the Ethernet communication executed between the fourth node 14 and the switching device 30 is interrupted in the communication network system 100.

As described above, the fourth node 14 is the target node. The external device 50 is communicably connected to the relay device 20 through the diagnostic port 40.

A diagnostic program is executed in the external device 50 connected to the diagnostic port 40. In this case, in a case where the diagnostic program is executed, a detection is made that the Ethernet communication executed between the fourth node 14 and the switching device 30 is interrupted.

As shown in FIG. 3, the switching device 30 transmits data indicating communication information for the fourth node 14 and the switching device 30 to the external device 50. The communication information is information indicating the type of communication that can be executed by the node. The switching device 30 transmits the data indicating the communication information to the external device 50 via the relay device 20.

As shown in and described with reference to FIG. 2, the switching device 30 stores the type of communication that can be executed for each node in the communication network system 100 based on the information acquired by the switching device 30 and the relay device 20. In FIG. 3, the switching device 30 generates the data indicating the communication information for the fourth node 14 and the switching device 30 based on the information stored in the switching device 30.

In FIG. 3, the external device 50 that has received the data indicating the communication information for the fourth node 14 and the switching device 30 confirms the received communication information. Then, as shown in FIG. 3, the external device 50 confirms that both the fourth node 14 and the switching device 30 can execute both the CAN communication and the Ethernet communication based on the received communication information.

As shown in FIG. 3, in a case where confirmation is made that both the fourth node 14 and the switching device 30 can execute both the CAN communication and the Ethernet communication, the external device 50 transmits a read request to the relay device 20. The read request is a message for requesting the relay device 20 to read the diagnosis information from the two nodes in which the Ethernet communication is interrupted. The external device 50 transmits the read request to the relay device 20 to cause the relay device 20 to execute the reading of the diagnosis information.

In the communication network system 100, the node has a self-abnormality diagnosis function. In a case where the node attempts to execute the Ethernet communication and an abnormality has occurred, the node detects that the abnormality has occurred in the node by the self-abnormality diagnosis function. The node in which the abnormality has occurred stores the diagnosis information that is a record indicating that the abnormality is detected by the self-abnormality diagnosis function after detecting that the abnormality has occurred in the node.

As shown in FIG. 3, the relay device 20 executes the reading of the diagnosis information from the fourth node 14 and the switching device 30 after receiving the read request. In the reading of the diagnosis information, the relay device 20 requests the node in which the Ethernet communication is interrupted to transmit the stored diagnosis information to the relay device 20 through the CAN communication. In the example shown in FIG. 3, the relay device 20 requests the fourth node 14 and the switching device 30 to transmit the stored diagnosis information to the relay device 20.

In a case where the transmission of the diagnosis information is requested, the node that stores the diagnosis information transmits the diagnosis information stored in the node to the relay device 20. In this case, the node that stores the diagnosis information transmits the diagnosis information to the relay device 20 through the CAN communication. In a case where the transmission of the diagnosis information is requested, the node that does not store the diagnosis information cannot transmit the diagnosis information to the relay device 20. That is, the node in which the abnormality is not detected by the self-abnormality diagnosis function does not transmit the diagnosis information to the relay device 20.

The relay device 20 ends the reading of the diagnosis information after a certain time has elapsed from the request to transmit the diagnosis information. As shown in FIG. 3, the relay device 20 transmits the data indicating the result of the reading of the diagnosis information to the external device 50 after executing the reading of the diagnosis information.

In a case where the relay device 20 receives the diagnosis information from the node in which the Ethernet communication is interrupted before a certain time has elapsed from the request to transmit the diagnosis information, the relay device 20 performs the following operation. The relay device 20 transmits information indicating the node in which the diagnosis information is recorded as the result of the reading. In a case where the relay device 20 does not receive the diagnosis information before a certain time has elapsed from the request to transmit the diagnosis information, the relay device 20 transmits information indicating that the diagnosis information is not recorded in any node as the result of the reading.

The external device 50 confirms the result of the reading received from the relay device 20 and specifies the location at which the failure has occurred. As shown in FIG. 3, in a case where the received result of the reading indicates that the fourth node 14 records the diagnosis information, the external device 50 determines that the failure has occurred in the fourth node 14. As shown in FIG. 3, in a case where the received result of the reading indicates that the switching device 30 records the diagnosis information, the external device 50 determines that the failure has occurred in the switching device 30. As shown in FIG. 3, in a case where the received result of the reading indicates that the diagnosis information is not recorded in any node, the external device 50 determines that the failure has occurred in the second communication cable 33B.

As described above, the failure diagnosis device 60 determines that the failure has occurred in the node in which the diagnosis information is recorded in a case where the diagnosis information is recorded in any one of the two nodes, which are the target node and the switching device 30. In addition, in a case where the diagnosis information is not recorded in any of the two nodes, which are the target node and the switching device 30, the failure diagnosis device 60 determines that the failure has occurred in the communication cable that connects the target node and the switching device 30.

The failure diagnosis device 60 confirms the communication information in the target node in which the Ethernet communication is interrupted and the switching device 30 before executing the reading of the diagnosis information. As a result, the failure diagnosis device 60 can perform the diagnosis in response to the design change, such as in a case where the node is added to the communication network system 100.

### Operation of First Embodiment

In a case where the Ethernet communication is interrupted, the failure diagnosis device 60 confirms the result of the reading of the diagnosis information executed by the CAN communication for the two nodes in which the communication is interrupted.

### Effects of First Embodiment

1-1 Even in a case where the Ethernet communication through the communication cable is interrupted, the failure diagnosis device 60 can confirm the presence or absence of the diagnosis information through the CAN communication through the communication bus. Then, the failure diagnosis device 60 can specify the location at which the failure has occurred by confirming the diagnosis information.

1-2The failure diagnosis device 60 is an external device 50 that is communicable with the node included in the first network including both the target node and the switching device 30. In a case where the Ethernet communication executed between the two nodes, which are the target node and the switching device 30, is interrupted, the failure diagnosis device 60 performs the following operation. The failure diagnosis device 60 executes the reading of the diagnosis information of the target node and the switching device 30 by using the CAN communication in the node included in the first network including both the target node and the switching device 30. The failure diagnosis device 60 confirms the result of the reading of the diagnosis information. The failure diagnosis device 60 determines, in a case where the diagnosis information is recorded in any one of the two nodes, which are the target node and the switching device 30, that the failure has occurred in the node in which the diagnosis information is recorded.

As a result, in a case where the Ethernet communication is interrupted, the external device 50 can specify the location at which the failure has occurred. (1-3) The failure diagnosis device 60 confirms the result of the reading of the diagnosis information. The failure diagnosis device 60 determines, in a case where the diagnosis information is not recorded in any of the two nodes, which are the target node and the switching device 30, that the failure has occurred in the communication cable that connects the target node and the switching device 30.

The failure diagnosis device 60 can confirm that the failure has not occurred in any node connected by the communication cable by confirming that the diagnosis information is not recorded in any node connected by the communication cable. Then, as a result, the failure diagnosis device 60 determines that the failure has occurred in the communication cable that connects the nodes.

The failure diagnosis device 60 can specify the location at which the failure has occurred even in a case where the failure has occurred in the communication cable instead of the node. (1-4) In the communication network system 100, the relay device 20 acquires the first notification indicating that the CAN communication can be executed from the node in which the CAN communication can be executed. In the communication network system 100, the switching device 30 acquires the second notification indicating that the Ethernet communication can be executed from the node in which the Ethernet communication can be executed. The failure diagnosis device 60 refers to the information acquired by the relay device 20 and the switching device 30. In a case where confirmation can be made that both the target node and the switching device 30 in which the Ethernet communication is interrupted can execute both the CAN communication and the Ethernet communication, the failure diagnosis device 60 performs the following operation. The failure diagnosis device 60 executes the reading of the diagnosis information in the node included in the first network including both the target node and the switching device 30.

In a case where both the two nodes in which the Ethernet communication is interrupted cannot execute both the CAN communication and the Ethernet communication, the diagnosis information cannot be read even in a case where the reading of the diagnosis information is executed. For example, in a case where at least one of the two nodes in which the Ethernet communication is interrupted cannot perform the CAN communication, the diagnosis information cannot be read even in a case where the reading of the diagnosis information is executed. In this case, the failure diagnosis device 60 cannot perform appropriate failure diagnosis.

The failure diagnosis device 60 confirms whether the diagnosis information can be read out for the node in which the Ethernet communication is interrupted based on the information based on the notification indicating that the communication is possible. The failure diagnosis device 60 executes the reading of the diagnosis information after confirming that the reading of the diagnosis information can be executed.

In a case where the diagnosis information cannot be read in the first place, the failure diagnosis device 60 can suppress erroneous determination by not executing the reading of the diagnosis information.

### Second Embodiment

Hereinafter, a second embodiment of the failure diagnosis device will be described with reference to the drawings. In the second embodiment, the failure diagnosis device 60 is provided in the communication network system 100. Specifically, the relay device 20 has a function as the failure diagnosis device 60. Hereinafter, the second embodiment will be described focusing on the different points from the first embodiment, and the same points will be simplified or omitted.

### Aspect of Communication Executed in a case where Ethernet Communication is Interrupted

The communication network system 100 of the second embodiment may not include the diagnostic port 40. In other words, in the second embodiment, the external device 50 may not be communicably connected to the relay device 20.

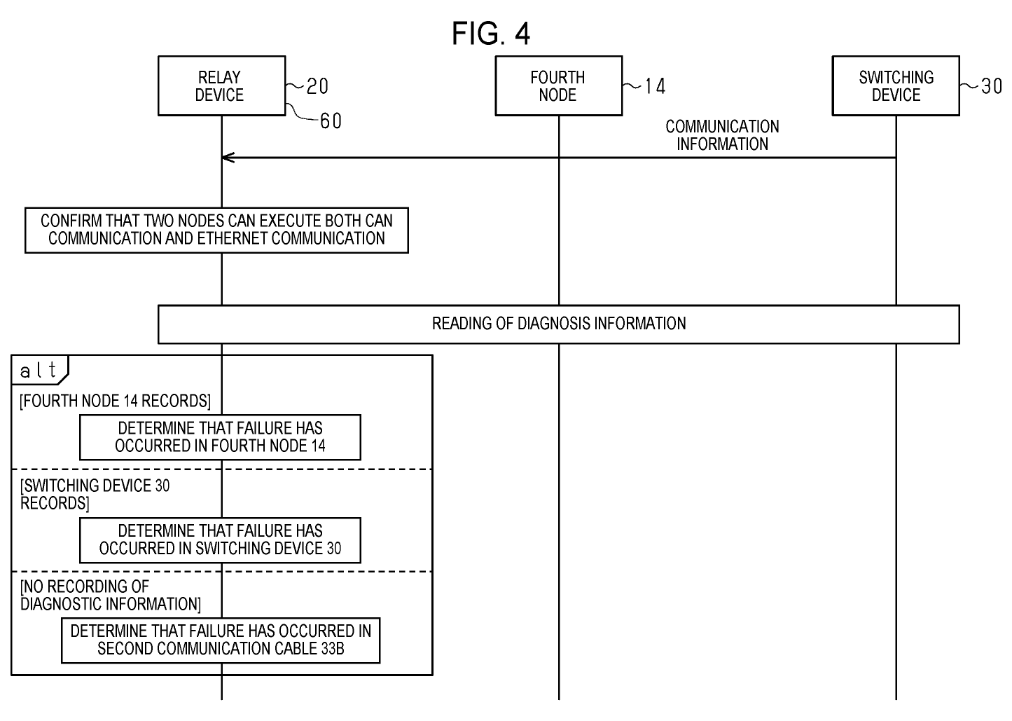

FIG. 4 shows an aspect of communication executed in a case where the Ethernet communication executed between the fourth node 14 and the switching device 30 is interrupted in the communication network system 100. In the communication network system 100 of the second embodiment, the relay device 20 executes the failure diagnosis as the failure diagnosis device 60.

In a case where the Ethernet communication executed between the fourth node 14 and the switching device 30 is interrupted, the switching device 30 transmits data indicating the communication information for the fourth node 14 and the switching device 30 to the relay device 20.

In FIG. 4, the relay device 20 that has received the data indicating the communication information for the fourth node 14 and the switching device 30 confirms the received communication information. As shown in FIG. 4, the relay device 20 confirms that both the fourth node 14 and the switching device 30 can execute both the CAN communication and the Ethernet communication after receiving the data indicating the communication information.

In a case where confirmation is made that both the fourth node 14 and the switching device 30 can execute both the CAN communication and the Ethernet communication, the relay device 20 performs the following operation. The relay device 20 executes the reading of the diagnosis information from the fourth node 14 and the switching device 30 through the CAN communication.

As shown in FIG. 4, the relay device 20 confirms the result of the reading after executing the reading of the diagnosis information, and specifies the location at which the failure has occurred. As shown in FIG. 4, in a case where the result of the reading indicates that the fourth node 14 records the diagnosis information, the relay device 20 determines that the failure has occurred in the fourth node 14. As shown in FIG. 4, in a case where the result of the reading indicates that the switching device 30 records the diagnosis information, the relay device 20 determines that the failure has occurred in the switching device 30. As shown in FIG. 4, in a case where the result of the reading indicates that the diagnosis information is not recorded in any node, the external device 50 determines that the failure has occurred in the second communication cable 33B.

As described above, one of the nodes included in the first network including both the target node and the switching device 30 executes the reading of the diagnosis information. At the same time, the failure diagnosis device 60 can specify the location at which the failure has occurred based on the result of the reading. The relay device 20 does not have to execute the reading of the diagnosis information and specify the location at which the failure has occurred as the failure diagnosis device 60 based on the result of the reading as shown in FIG. 4. For example, any one of the first node 11 to the sixth node 16 may execute the reading of the diagnosis information and specify the location at which the failure has occurred as the failure diagnosis device 60 based on the result of the reading.

The target node or the switching device 30 may execute the reading of the diagnosis information and specify the location at which the failure has occurred as the failure diagnosis device 60 based on the result of the reading. In this case, the node that executes the failure diagnosis confirms whether the node stores the diagnosis information in a case of reading the diagnosis information, and confirms whether the other party of the Ethernet communication stores the diagnosis information through the CAN communication.

### Operation and Effects of Second Embodiment

2-1 The failure diagnosis device 60 of the second embodiment exhibits the effects of (1-1), (1-3), and (1-4) in the first embodiment.

2-2 The failure diagnosis device 60 of the second embodiment is one of the nodes included in the first network including both the target node and the switching device. The failure diagnosis device 60 executes, in a case where the Ethernet communication executed between the two nodes, which are the target node and the switching device 30, is interrupted, the reading of the diagnosis information of the target node and the switching device 30 by using the CAN communication. The failure diagnosis device 60 confirms the result of the reading of the diagnosis information. The failure diagnosis device 60 determines, in a case where the diagnosis information is recorded in any one of the two nodes, which are the target node and the switching device 30, that the failure has occurred in the node in which the diagnosis information is recorded.

As a result, in a case where the Ethernet communication is interrupted, the node in the communication network system 100 can specify the location at which the failure has occurred.

### Other Embodiments

Each of the embodiments can be modified and carried out as follows. Each of the embodiments and the following modification can be carried out in combination within a technically consistent range.

The switching device 30 does not have to store the type of communication that can be executed for each node in the communication network system 100 based on the information acquired by the switching device 30 and the relay device 20. For example, the relay device 20 may store the type of communication that can be executed for each node in the communication network system 100 based on the information acquired by the switching device 30 and the relay device 20.

The node that can already execute the CAN communication may transmit the first notification in a case where the power is supplied and the setup for communicating with the other node is completed.

The node that can already execute the Ethernet communication may transmit the second notification in a case where the power is supplied and the setup for communicating with the other node is completed.

The external device 50 of the first embodiment may request the relay device 20 to read the diagnosis information without confirming that both the target node and the switching device 30 can execute both the CAN communication and the Ethernet communication.

The node connected to the external device 50 via the diagnostic port 40 may be one of the nodes included in the first network including both the target node and the switching device 30. That is, the relay device 20 does not have to be used as in the first embodiment. For example, the external device 50 may be communicably connected to the switching device 30 via the diagnostic port 40. For example, the external device 50 may be communicably connected to any one of the first node 11 to the sixth node 16 via the diagnostic port 40.

One of the nodes included in the first network including both the target node and the switching device 30 may execute the reading of the diagnosis information. Then, the other node in the communication network system 100 may specify the location at which the failure has occurred as the failure diagnosis device 60.

What is claimed is:

1. A failure diagnosis device for a communication network system, wherein:
the communication network system includes
a plurality of nodes,
a plurality of communication buses,
a plurality of communication cables,
a first network in which a relay device that relays CAN communication to which a CAN protocol is applied and a group of nodes are connected in parallel through the communication buses to perform the CAN communication, the relay device and the group of nodes being included in the plurality of nodes, and
a second network in which a switching device that relays Ethernet communication to which an Ethernet protocol is applied and another group of nodes are connected to each other in a one-to-one manner by the communication cables to perform the Ethernet communication, the switching device and the other group of nodes being included in the plurality of nodes;
the relay device and the switching device are connected to each other through the communication buses;
the node included in the first network including both a target node and the switching device, the target node being the node that is connected to the relay device through the communication bus and is connected to the switching device through the communication cable, executes, when the Ethernet communication executed between the target node and the switching device is interrupted, reading of diagnosis information that is a record indicating that an abnormality is detected by a self-abnormality diagnosis function of the target node and the switching device by using the CAN communication; and
the failure diagnosis device confirms a result of the reading of the diagnosis information, and determines, when the diagnosis information is recorded in any one of two nodes that are the target node and the switching device, that a failure has occurred in the node in which the diagnosis information is recorded, the node being one of the target node and the switching device.

2. The failure diagnosis device according to claim 1, wherein:
the failure diagnosis device is an external device that is communicable with the node included in the first network including both the target node and the switching device;
the failure diagnosis device causes the node included in the first network including both the target node and the switching device to execute the reading of the diagnosis information of the target node and the switching device by using the CAN communication, when the Ethernet communication executed between the two nodes that are the target node and the switching device is interrupted; and
the failure diagnosis device confirms a result of the reading of the diagnosis information, and determines, when the diagnosis information is recorded in any one of the two nodes that are the target node and the switching device, that the failure has occurred in the node in which the diagnosis information is recorded, the node being one of the target node and the switching device.

3. The failure diagnosis device according to claim 1, wherein:
the failure diagnosis device is one of the plurality of nodes included in the first network including both the target node and the switching device;
the failure diagnosis device executes, when the Ethernet communication executed between the two nodes that are the target node and the switching device is interrupted, reading of the diagnosis information of the target node and the switching device by using the CAN communication; and
the failure diagnosis device confirms a result of the reading of the diagnosis information, and determines, when the diagnosis information is recorded in any one of the two nodes that are the target node and the switching device, that the failure has occurred in the node in which the diagnosis information is recorded, the node being one of the target node and the switching device.

4. The failure diagnosis device according to claim 1, wherein the failure diagnosis device confirms the result of the reading of the diagnosis information, and determines, when the diagnosis information is not recorded in any of the two nodes that are the target node and the switching device, that the failure has occurred in the communication cable that connects the target node and the switching device.

5. The failure diagnosis device according to claim 2, wherein:
in the communication network system,
the relay device acquires a first notification indicating that the CAN communication is executable from the node in which the CAN communication is executable, and
the switching device acquires a second notification indicating that the Ethernet communication is executable from the node in which the Ethernet communication is executable; and
the failure diagnosis device causes the node included in the first network including both the target node and the switching device to execute the reading of the diagnosis information, when confirmation is made that both the target node and the switching device in which the Ethernet communication is interrupted are able to execute both the CAN communication and the Ethernet communication by referring to information acquired by the relay device and the switching device.
